(19) United States
(12) Patent Application Publication
(10) Pub. No.: US 2010/0141094 A1
(43) Pub. Date: Jun. 10, 2010

(54) PIEZOELECTRIC ENERGY HARVESTING SYSTEM

(75) Inventors: Hyung-Kyu Lee, Edina, MN (US); Michael Xuefei Tang, Bloomington, MN (US)

Correspondence Address: CAMPBELL NELSON WHIPPS, LLC, HISTORIC HAMM BUILDING, 408 SAINT PETER STREET, SUITE 240, ST. PAUL, MN, 55102, US

(73) Assignee: SEAGATE TECHNOLOGY LLC, Scotts Valley, CA (US)

(21) Appl. No.: 12/501,158

(22) Filed: Jul. 10, 2009

Related U.S. Application Data
(60) Provisional application No. 61/120,191, filed on Dec. 5, 2008.

(51) Int. Cl. H02N 2/18; F03G 7/08

(52) U.S. Cl. 310/339

(57) ABSTRACT

A mechanical energy harvester, such as for an electronic system such as a sensor system. The energy harvester has a spring with one end connected to a support structure, and a piezoelectric material on the spring. An electronics package is supported on the spring, the electronics package comprising at least one component selected from the group consisting of rectifier(s), storage component(s), and integrated circuit(s).

### RELATED APPLICATION

This application claims priority to U.S. provisional patent application No. 61/120,191, filed on Dec. 5, 2008 and titled “Self-powered remote sensor system”. The entire disclosure of application No. 61/120,191 is incorporated herein by reference.

### BACKGROUND

With the desire to increase the limited lifetime of the batteries and the electronics systems, various attempts have been made to produce self-powered systems with a small scale (e.g., a few cubic centimeters to a few hundred cubic centimeters) power harvester as a substitute for the battery. Naturally occurring power sources, such as solar energy and heat or thermal energy, have been used as power harvesting structures. Better designs for smaller and more efficient power harvesters are needed.

### BRIEF SUMMARY

The present disclosure relates to an integrated self-powered electronic system having a piezoelectric power harvesting structure and electronic components such as sensors, storage capacitors, and signal processing integrated circuit (IC) chips. By integrating the electronic components in the vibrating mass of the power harvester, the power generated within the limited package size and weight can be maximized. Additionally, the complexity and cost of self-powered systems can be reduced.

This disclosure provides, in one exemplary embodiment, a mechanical energy harvester that has a spring having a first end and an opposite second end, the spring connected to a support structure at the first end, with a piezoelectric material on the spring. An electronics package is supported on the spring, the electronics package comprising at least one component selected from the group consisting of rectifier(s), storage component(s), and integrated circuit(s).

This disclosure also provides, in another exemplary embodiment, a self-powered system that has a piezoelectric spring configured for vibrational movement, and an electronics package supported on the piezoelectric spring, the package comprising at least one component selected from the group consisting of rectifier(s), storage component(s), and integrated circuit(s).

These and various other features and advantages will be apparent from a reading of the following detailed description.

### BRIEF DESCRIPTION OF THE DRAWINGS

The disclosure may be more completely understood in consideration of the following detailed description of various embodiments of the disclosure in connection with the accompanying drawings, in which:

FIG. 1 is a block diagram of a configuration of a self-powered electronic device;

FIG. 2 is a schematic diagram of an embodiment of a piezoelectric power harvester suitable for use in the self-powered electronic device of FIG. 1;

FIG. 3 is a schematic diagram of an embodiment of a piezoelectric power harvester suitable for use in the self-powered electronic device of FIG. 1;

FIG. 4 is a block diagram of a configuration of an integrated self-powered electronic system;

FIG. 5 is a schematic diagram of an embodiment of electronics suitable for use in the self-powered electronic system of FIG. 4;

FIG. 6 is a schematic diagram of an embodiment of electronics suitable for use in the self-powered electronic system of FIG. 4;

FIG. 7 is a schematic side view of an embodiment of an energy harvesting structure;

FIG. 8 is a schematic perspective view of the energy harvesting structure of FIG. 7;

FIG. 9 is a schematic side view of an embodiment of an energy harvesting structure;

FIG. 10 is a schematic top view of the energy harvesting structure of FIG. 9; and

FIG. 11 is a schematic diagram of an illustrative self-powered remote sensing system to monitor an object.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

This disclosure describes self-powered piezoelectric electronic systems, such as remote sensor systems. Piezoelectric systems use piezoelectric material to convert strain in a spring into electricity or other power. In some embodiments, the disclosure describes integrated piezoelectric self-powered electronic systems that can maximize the generated power in a small package size and weight by integrating all or part of electronic components into the vibrating mass. In some of these embodiments, the systems include a piezoelectric mechanical spring structure with electrodes for power harvesting, storage devices (capacitor or secondary battery), rectifiers, and other ICs integrated as a mass.

In the following description, reference is made to the accompanying set of drawings that form a part hereof and in which are shown by way of illustration several specific embodiments. It is to be understood that other embodiments are contemplated and may be made without departing from the scope or spirit of the present disclosure. The following detailed description, therefore, is not to be taken in a limiting sense. Any definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

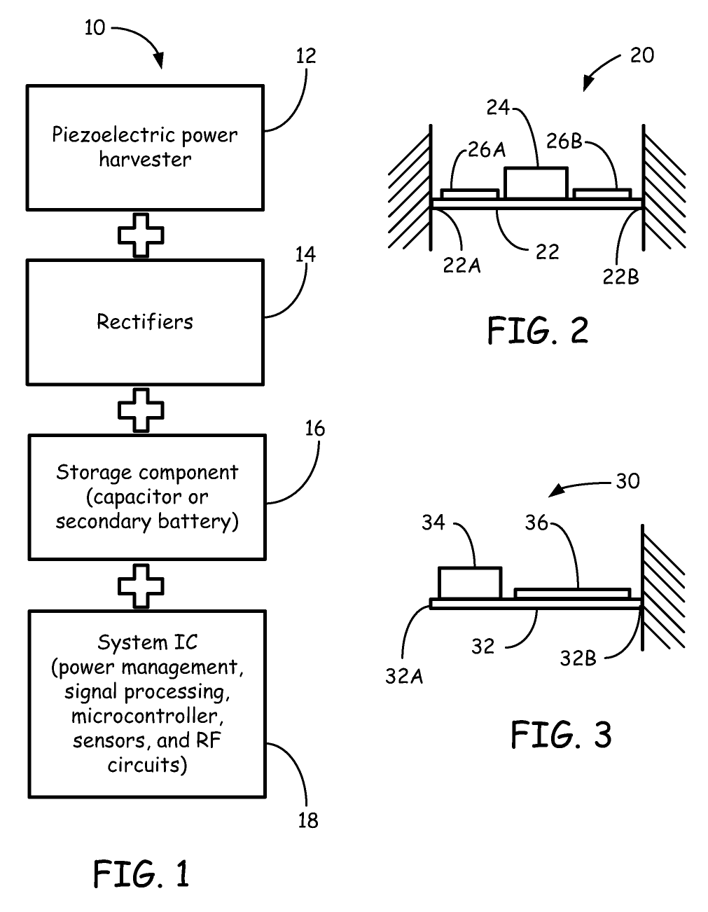

FIG. 1 illustrates a configuration of a self-powered electronic sensor system that includes a piezoelectric vibration power harvester. Electronic system 10, e.g., a sensor system, has a piezoelectric power harvester 12, rectifier(s) 14, a storage component 16 (such as a capacitor or a secondary battery), and integrated circuit systems 18 (such as a power management mechanism, signal processing device, a microcontroller, various sensors, and/or radio frequency (RF) circuits). Piezoelectric power harvester 12 is separately packaged and assembled with the other components.

The electrical power to operate sensor system 10 is generated by piezoelectric power harvester 12 by ambient mechanical vibration. The power can be used, for example, to make measurements and/or transmit data to a remote location. FIGS. 2 and 3 illustrate two embodiments of vibration piezoelectric harvesters that have a mass supported by a spring and that include piezoelectric material. FIG. 2 illustrates a power harvester 20 having a spring 22 having a first end 22A and a second opposite end 22B. In this embodiment, spring 22 is a bridge spring with each end 22A, 22B connected to a supporting structure, such as a package wall. Positioned on spring 22, in this embodiment centered between end 22A and end 22B, is a mass 24. On each side of mass 24 is piezoelectric material 26A, 26B. Piezoelectric material 26A, 26B includes electrodes to operably harvest the power generated by spring 22 and piezoelectric material 26A, 26B. FIG. 2 illustrates a power harvester 20 having a spring 32 having a first end 32A and a second opposite end 32B. In this embodiment, spring 32 is a cantilever with only one end, e.g., end 32B, connected to a supporting structure, such as a package wall. Positioned on spring 32, in this embodiment closer to end 32A than end 32B, is a mass 34. Between mass 34 and end 32B is piezoelectric material 36. Piezoelectric material 36 includes electrodes to operably harvest the power generated by spring 32 and piezoelectric material 36. The external vibration on harvester 20, 30 (for example, caused by tire rotation) makes mass 24, 34 vibrate straining springs 22, 32 and piezoelectric material 26A, 26B, 36 on springs 22, 32, respectively. The strained piezoelectric material 26A, 26B, 36 generates power in the form of electric charges. The generated electric charges may be converted from alternating current (AC) to direct current (DC) via rectifier 14 (of system 10 of FIG. 1) before being stored in storage component 16 (of system 10 of FIG. 1). The electric charge generated by harvester 20, 30 is a function of, for example, the frequency and amplitude of the vibration of mass 24, 34. The stored charge is consumed by the sensor system. Because the power harvester (e.g., harvester 20, 30) and other electronic components (e.g., rectifier(s) 14, storage component 16, system IC 18, etc.) are separate components in these configurations, the physical size of harvester 20, 30 is limited to a small package, and thus the power obtained is also generally small.

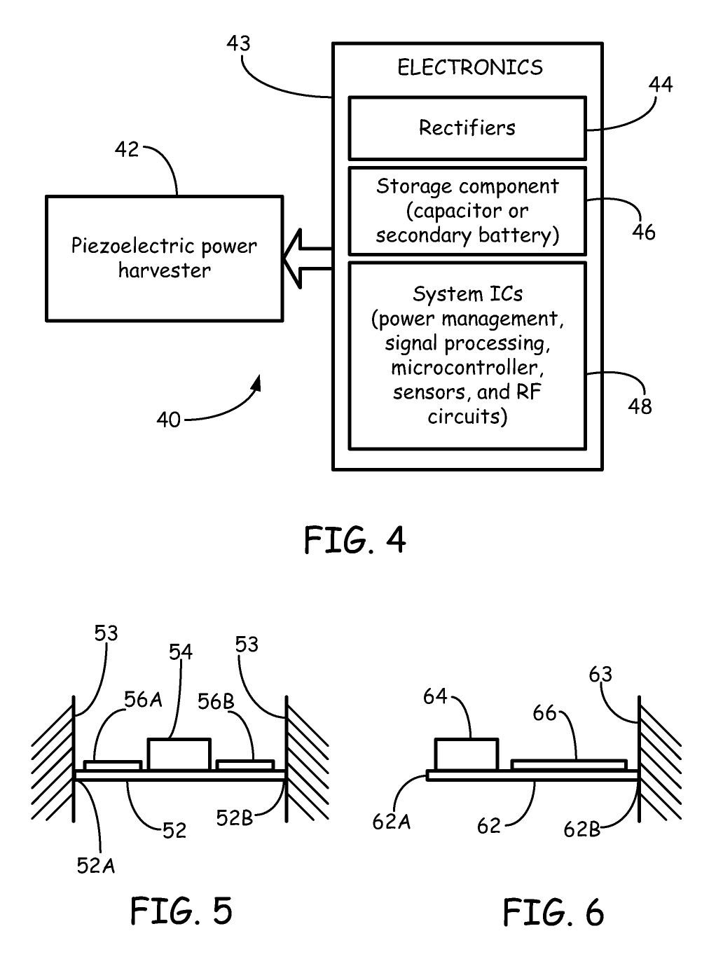

To increase (and in some embodiments maximize) the power generated within the small package, an integrated self-powered system is provided. In these embodiments, multiple electronic parts or components, in some embodiments all of the electronic components, are integrated into the mass on the spring. In some embodiments, the electronic components are the mass, and no additional extraneous material is used for weight. FIG. 4 illustrates a configuration of an integrated self-powered electronic system that includes a piezoelectric vibration power harvester with all the other components combined into one package suspended on the spring. System 40 has a piezoelectric power harvester 42 that includes an electronics package 43 having therein rectifier(s) 44, a storage component 46 (such as a capacitor or a secondary battery), and integrated circuit systems 48 (such as a power management mechanism, signal processing device, a microcontroller, various sensors, and/or RF circuits). In system 40, all the electronic components, including rectifier(s), storage device(s), and system circuits form a single mass. In other embodiments, some parts may be present separate from electronics package 43 and power harvester 42. For example, in some designs, only power circuits (e.g., IC systems 48) and storage device(s) (e.g., storage component 46) are integrated into the mass. By integrating multiple electronic components into electronics package 43 as part of power harvester 42, the efficiency of harvester 42 and the power generated by harvester 42 are increased, and the size of system 40 is decreased.

In some embodiments, electronics package 43 has a largest dimension of no more than about 10 cm and a volume of no more than about 1000 cm³. In other embodiments, electronics package 43 has a largest dimension of no more than about 5 cm or about 1 cm and a volume of no more than about 10 cm³. Suitable volumes of electronics package 43 include about 1-1000 cm³, and about 10-200 cm³. The dimensions and/or volume of package 43 could be larger or smaller, as the actual dimensions and volume will depend on the specific components, the application and the desired power level.

Additionally or alternately, in some embodiments, electronics package 43 has a weight (mass) of at least about 1 gram. In other embodiments, electronics package 43 has a weight (mass) of at least about 10 grams and at least about 100 grams in other embodiments. The weight of package 43 could be larger or smaller, as the actual weight will depend on the specific components, the application and the desired power level.

Piezoelectric power harvester 42 uses ambient vibration to generate power and power remote sensor 40. The power generated is stored by storage component 46 until needed by sensor 40, either to measure a condition or parameter or to transmit the measured condition or parameter to a remote location. Although the power level produced by power harvester 42 will depend on the specific design of power harvester 42, its application, and the desired power objected, in some embodiments the expected generated energy by integrated piezoelectric harvesters 42 from mechanical vibration will be at least 1 microwatt. In some embodiments, the power produced will be from tens of microwatts to tens of milliwats (e.g., 10 μW to 50 mW, or e.g., 50 μW to 10 mW).

FIGS. 5 and 6 illustrate two embodiments of integrated vibration piezoelectric harvesters that have an electronics package supported by a spring and that include piezoelectric material. FIG. 5 illustrates a power harvester 50 having a spring 52 having a first end 52A and a second opposite end 52B. In this embodiment, spring 52 is a bridge spring with each end 52A, 52B connected to a supporting structure, such as a package wall 53. Positioned on spring 52, in this embodiment centered between end 52A and end 52B, is an electronic mass 54, composed of electronic parts (e.g., rectifiers, storage devices, and/or system circuits). On each side of electronic mass 54 is piezoelectric material 56A, 56B that includes electrodes. FIG. 6 illustrates a power harvester 60 having a spring 62 having a first end 62A and a second opposite end 62B. In this embodiment, spring 62 is a cantilever with only one end, e.g., end 62B, connected to a supporting structure, such as a package wall 63. Positioned on spring 62, in this embodiment closer to end 62A than end 62B, is an electronic mass 64. Between electronic mass 64 and end 62B is piezoelectric material 66 that includes electrodes to operably harvest the power generated by spring 62 and piezoelectric material 66.

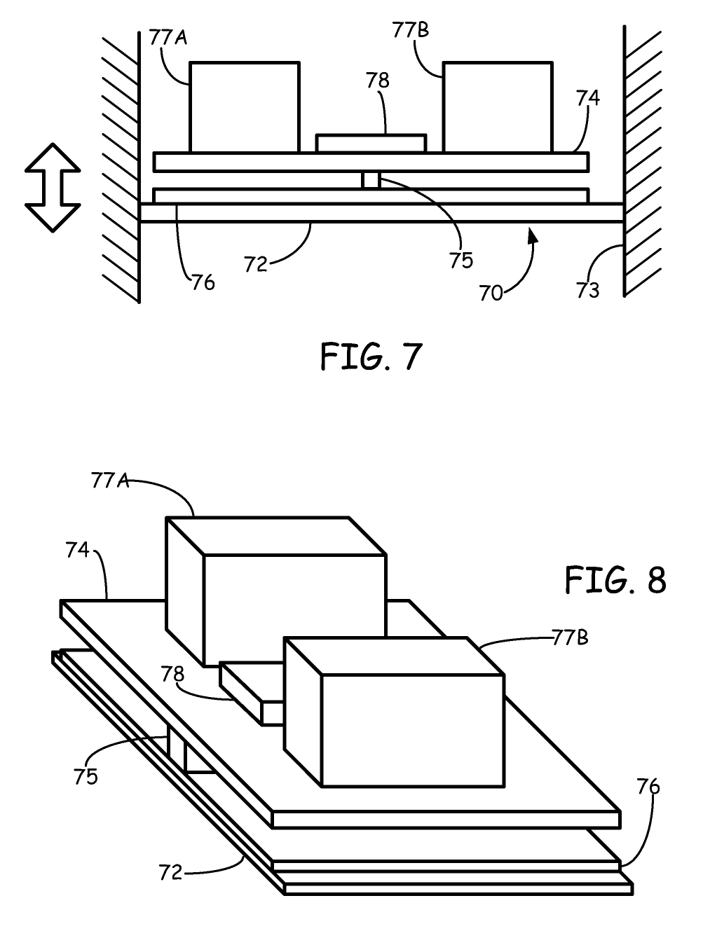

FIGS. 7 and 8 illustrate a possible implementation of an integrated vibration piezoelectric harvester in an electronic system, in particular, an out-of-plane power harvesting structure. By use of the term “out-of-plane”, what is intended is that the power harvester generates power due to vibrations in the vertical direction, in the direction of the electronic mass. That is, the vibration is normal to the carrier of the electronic package mass. The direction of vibration is indicated in FIG. 7.

The electronic system of FIGS. 7 and 8 is powered by a power harvester 70 having a spring 72. In this embodiment, spring 72 is a bridge spring with both ends connected to a supporting structure, such as a package wall 73, however in other embodiments, spring 72 may be a cantilever with only one end connected to a supporting structure. Supported on spring 72 is a carrier 74 (e.g., a printed circuit board) on which is an electronic mass that includes storage components 77A, 77B and circuitry 78. The components that form the electronic mass (i.e., storage components 77A, 77B and circuitry 78 in this embodiment) may or may not be physically housed in a package. A connector 75 fixedly attaches carrier 74 to spring 72, so that the force from the electronic mass is transferred to spring 72 and the electronic mass experiences vibrations from spring 72. Connector 75 may be physically centered on each of spring 72 and carrier 74. In some embodiments, carrier 75 is positioned to facilitate balancing of carrier 74 with its electronic mass on spring 72. On spring 72, in this embodiment on the side of spring 72 closest to carrier 74, is piezoelectric material 76 that includes electrodes. In other embodiments, piezoelectric material 76 may be on the side of spring 72 opposite carrier 74. For this in-plane electronic system, carrier 74 is parallel to spring 72 and to piezoelectric material 76.

Piezoelectric power harvester 70 and others of this disclosure can be formed by applying a piezoelectric material on spring 72, which may be, for example, metal or polymeric. The piezoelectric material may be either crystalline, ceramic, or other piezoelectric material and may be in the form of a layer, fibers, or crystals, and may be deposited or otherwise formed on spring 72 or may be formed and then subsequently applied to spring 72. Examples of suitable piezoelectric materials include lead zirconate titanate (PZT), barium titanate, barium strontium titanate (BST), polyvinylidene fluoride (PVDF), zinc oxide, aluminum nitride, quartz, berlinite, gallium orthophosphate, and tourmaline. In alternate embodiments, spring 72 itself may be formed of piezoelectric material or have piezoelectric material therein.

Harvesting structure 70 can be assembled to carrier 74 via connector 75 by using, for example, solder, adhesive, mechanical fasteners such as screws, bolts and nuts, or a clamping mechanism. In some embodiments, connector 75 is the solder, adhesive, mechanical fastener, or clamping mechanism. In some embodiments, harvesting structure 70, particularly spring 72, is clamped to its supporting structure (e.g., package 73).

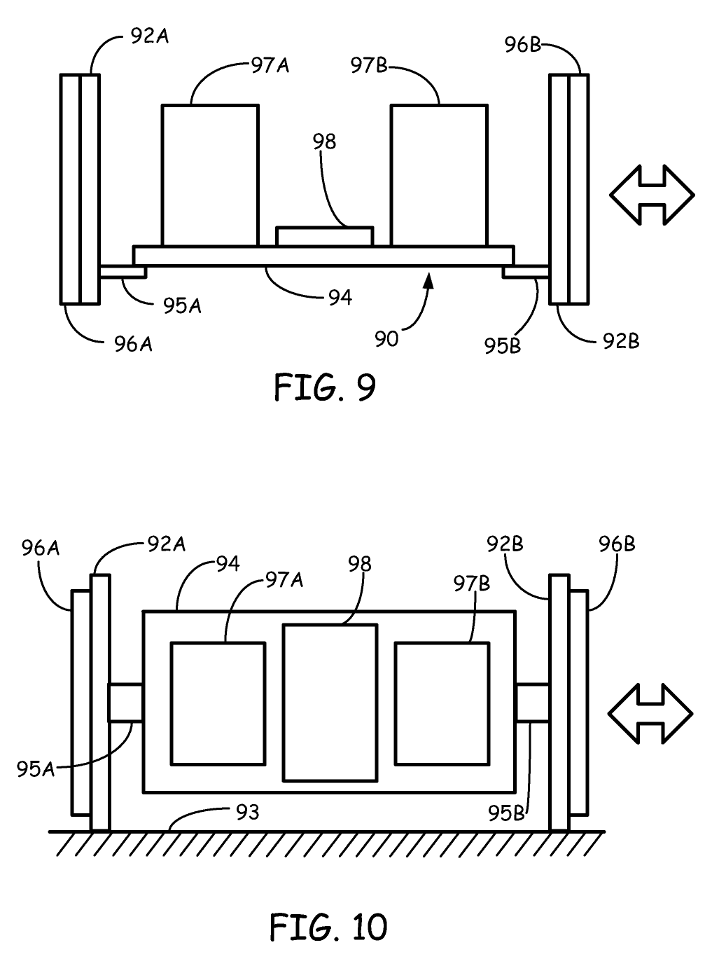

FIGS. 9 and 10 illustrate a possible implementation of an integrated vibration piezoelectric harvester in an electronic system, in particular, an in-plane power harvesting structure. By use of the term “in-plane”, what is intended is that the power harvester generates power due to vibrations not in the vertical direction, but, in a direction orthogonal to the electronic mass. That is, the vibration is parallel to the carrier of the electronic package mass.

The direction of vibration is indicated in FIGS. 9 and 10. The basic electronic structure is similar to the structure of FIGS. 7 and 8 except that the harvesting structure is attached to the sides of the carrier for this structure.

The electronic system of FIGS. 9 and 10 is powered by a power harvester 90 having a spring, in this embodiment two spring portions 92A, 92B. In this embodiment, each spring portion 92A, 92B is a cantilever spring with one end connected to a supporting structure, such as a package wall 93, however in other embodiments, each spring portion 92A, 92B may be a bridge spring with both ends connected to a supporting structure. Supporting connected to spring portions 92A, 92B is a carrier 94 (e.g., a printed circuit board) on which is an electronic mass that includes storage components 97A, 97B and circuitry 98. The components that form the electronic mass (i.e., storage components 97A, 97B and circuitry 98 in this embodiment) may or may not be physically housed in a package. Connectors 95A, 95B fixedly attach carrier 94 to spring portions 92A, 92B, respectively, so that the force from the electronic mass is transferred to spring portions 92A, 92B and the electronic mass experiences vibrations from spring portions 92A, 92B. Connectors 95A, 95B may be physically centered on each of spring portion 92A, 92B and carrier 94. On each spring portion 92A, 92B, in this embodiment on the side of spring portion 92A, 92B opposite from carrier 94, is piezoelectric material 96A, 96B that includes electrodes. In other embodiments, piezoelectric material 96A, 96B may be on the side of spring portion 92A, 92B closest to carrier 94. For this out-of-plane electronic system, carrier 94 is orthogonal to spring portions 92A, 92B and to piezoelectric material 96A, 96B.

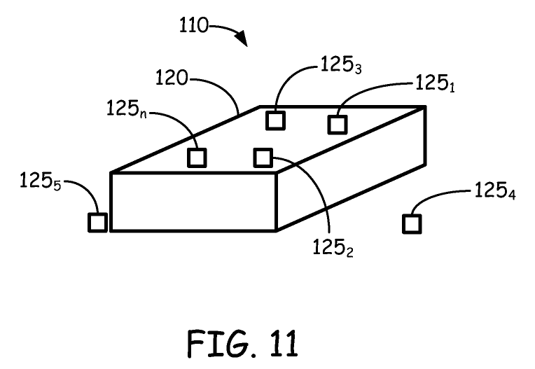

In FIG. 11, a self-powered remote sensor system 110 is illustrated monitoring a condition of an object 120. System 100 has at least one self-powered sensor device 125 positioned to monitor a condition of object 120. While six self-powered sensor devices 125₁, 125₂, 125₃, 125₄, 125₅, 125ₙ are illustrated in FIG. 11 as forming system 110, any number of sensor devices 125 can be arranged and monitored, as desired. Sensor device 125 may be positioned on or in contact with object 120 or be positioned proximate to object 120 or be spaced from object 120. Sensor 125 should be positioned to experience mechanical vibrations from either object 120 of from a different source in order to power sensor device 125. Object 120 can be anything to be monitored. In many embodiments object 120 is capable of providing sufficient vibration energy to self-powered sensor device 125. In some embodiments object 120 is a portion of a fixed structure such as, for example, a building, bridge, road, and the like. In some embodiments object 120 is a portion of a moving structure such as, for example, a vehicle, plane, human body, and the like.

Sensor 125 can be configured to monitor or measure any useful parameter of interest. For example, sensor 125 can be in the form of a strain gauge, temperature sensor, pressure sensor, magnetic sensor, accelerometer, acoustic receiver, or other form of sensor known to those skilled in the art. If more than one sensor 125 is installed to monitor object 120, each sensor 125 can be configured to monitor the same or different parameter of interest. Sensor 125 may be wireless or hardwired, and output from sensor 125 can be an analog or digital signal.

Thus, embodiments of the PIEZOELECTRIC ENERGY HARVESTING SYSTEM are disclosed. The implementations described above and other implementations are within the scope of the following claims. One skilled in the art will appreciate that the present disclosure can be practiced with embodiments other than those disclosed. The disclosed embodiments are presented for purposes of illustration and not limitation, and the present invention is limited only by the claims that follow.

What is claimed is:

1. A mechanical energy harvester comprising:
a spring having a first end and an opposite second end, the spring connected to a support structure at the first end;
a piezoelectric material on the spring; and
an electronics package supported on the spring, the electronics package comprising at least one component selected from the group consisting of rectifier(s), storage component(s), and integrated circuit(s).

2. The energy harvester of claim 1, wherein the energy harvester generates electrical power of at least 10 microwatts.

3. The energy harvester of claim 1 wherein the electronics package comprises at least two components selected from the group consisting of rectifier(s), storage component(s), and integrated circuit(s).

4. The energy harvester of claim 3 wherein the electronics package comprises storage component(s) and integrated circuit(s).

5. The energy harvester of claim 1 wherein the electronics package has a volume of 1000 cm³ or less.

6. The energy harvester of claim 5 wherein the electronics package has a volume of 200 cm³ or less.

7. the energy harvester of claim 1 wherein the electronics package has a mass of at least 1 gram.

8. The energy harvester of claim 1 wherein the spring is a bridge spring further comprising the second end connected to a support structure.

9. The energy harvester of claim 1 wherein the piezoelectric material is on a side of the spring closer to the electronics package.

10. The energy harvester of claim 1 wherein the piezoelectric material is on a side of the spring farther from the electronics package.

11. The energy harvester of claim 1 wherein the energy harvester is an in-plane system.

12. The energy harvester of claim 1 wherein the energy harvester is an out-of-plane system.

13. A self-powered system comprising:
a piezoelectric spring configured for vibrational movement; and
an electronics package supported on the piezoelectric spring, the package comprising at least one component selected from the group consisting of rectifier(s), storage component(s), and integrated circuit(s).

14. The sensor system of claim 13 wherein the piezoelectric spring comprises piezoelectric material incorporated into the spring.

15. The sensor system of claim 13 wherein the piezoelectric material is on a side of the spring closer to the electronics package.

16. The sensor system of claim 13 wherein the piezoelectric material is on a side of the spring farther from the electronics package.

17. The sensor system of claim 13 wherein the electronics package comprises at least two of rectifier(s), a storage component, and integrated circuitry.

18. The sensor system of claim 14 wherein the electronics package comprises a storage component and integrated circuitry.

19. The sensor system of claim 13 wherein the electronics package has a volume of 1000 cm³ or less.

20. A mechanical energy harvester comprising:
a piezoelectric spring configured for vibrational movement, the spring having a first end and an opposite second end, the spring connected to a support structure at each of the first end and the second end; and
an electronics package supported on the spring, the electronics package comprising at least one component selected from the group consisting of rectifier(s), storage component(s), and integrated circuit(s).
